(19) United States
(12) Patent Application Publication
(10) Pub. No.: US 2011/0217594 A1
(43) Pub. Date: Sep. 8, 2011

(54) ELECTRODE BODY, AND LITHIUM SECONDARY BATTERY EMPLOYING THE ELECTRODE BODY

(75) Inventor: Hiroki Awano, Susono-shi (JP)

(73) Assignee: TOYOTA JIDOSHA KABUSHIKI KAISHA, TOYOTA-SHI, AICHI-KEN (JP)

(21) Appl. No.: 12/676,628

(22) PCT Filed: Sep. 5, 2008
(86) PCT No.: PCT/IB08/02957

§ 371 Date: Mar. 5, 2010

(30) Foreign Application Priority Data
Sep. 7, 2007 (JP) 2007-232822

(51) Int. Cl. H01M 4/62

(52) U.S. Cl. 429/232

(57) ABSTRACT

An electrode body has a current collector, and an electrode layer that is formed on the current collector and that has an electrode active material and a conductive material. The concentration of the conductive material at a current collector-side surface of the electrode layer is lower than the concentration of the conductive material at an opposite-side surface that is opposite from the current collector-side surface.

### BACKGROUND OF THE INVENTION

1. Field of the Invention

The invention relates to an electrode body that makes the utilization rate of an electrode active material uniform in the thickness direction of the electrode layer, and a lithium secondary battery that employs the electrode body.

2. Description of the Related Art

Along the trend of size reduction of personal computers, video cameras, cellular phones or the like, the field of information-related appliances and communication appliances is seeing the practical and wide-spread use of lithium secondary batteries as power sources used for these appliances for the reason that the lithium secondary batteries are high in energy density. Besides, in the field of motor vehicles, the development of electric motor vehicles is being hastened due to environmental issues and resource issues. A lithium secondary battery is considered also as a power source of the electric motor vehicles.

The positive electrode layer of a lithium secondary battery ordinarily contains a positive electrode active material (e.g., LiCoO₂) that stores and releases lithium ions, and a conductive material (e.g., carbon black) for improving electro-conductivity. From the viewpoint of energy density, adding the conductive material to the positive electrode active material relatively reduces the content of the electrode active material, and is therefore not preferable. However, since the positive electrode active material, such as LiCoO₂, is generally low in electro-conductivity, it is necessary to add the conductive material in order to ensure good charge/discharge characteristics.

Therefore, in the related arts, a positive electrode layer in which a positive electrode active material and the conductive material are uniformly dispersed is widely used. However, in such lithium secondary batteries, since the positive electrode active material and the conductive material are merely dispersed uniformly, it is difficult to obtain an optimal electro-conductivity.

Regarding this, Japanese Patent No. 3477981, for example, discloses a non-aqueous electrolyte secondary battery equipped with an electrode layer that has the concentration gradient in which the concentration of the conductive material in the electrode active material in the vicinity of the current collector is higher than the concentration of the conductive material in the electrode active material at a location remote from the current collector. In this non-aqueous electrolyte secondary battery, since the conductive material is distributed so as to be present in appropriate amounts in appropriate portions, there is an advantage of being able to reduce the amount of the conductive material employed and relatively increase the amount of the electrode active material employed.

However, if the concentration of the conductive material in the electrode layer is made high at the current collector side and low at an opposite side as Japanese Patent No. 3477981, there arises a problem of the utilization rate of the electrode active material becoming nonuniform. Generally, the electronic resistance of the electrode layer is high at locations remote from a current collector. However, in the electrode layer having the concentration gradient of the conductive material as described above, the concentration of the conductive material at locations remote from the current collector is low. Therefore, the non-uniformity of the electro-conductivity in the thickness direction of the electrode layer becomes significant. Therefore, for example, if high-rate charging/discharging is performed, there occurs a phenomenon in which only the electrode active material present in the vicinity of the current collector is utilized, and the electrode active material present at locations remote from the current collector is scarcely utilized. In consequence, there is a problem of being unable to achieve sufficient energy density. Besides, since only the electrode active material in the vicinity of the current collector is utilized, the electrode active material degrades locally, giving rise to a problem of decline in the cycle characteristics.

### SUMMARY OF THE INVENTION

The invention provides an electrode body that is excellent in the rate characteristics and the cycle characteristics, and also provides a lithium secondary battery that employs the electrode body.

An electrode body according to a first aspect of the invention has a current collector, and an electrode layer that is formed on the current collector and that contains an electrode active material and a conductive material, and the concentration of the conductive material at a current collector-side surface of the electrode layer is lower than the concentration of the conductive material at an opposite-side surface that is opposite from the current collector-side surface.

According to the invention, since the concentration of the conductive material in the electrode layer is low at the current collector-side surface and high at the opposite-side surface, the electro-conductivity can be uniformed in the thickness direction of the electrode layer. Due to this construction, for example, even in the case where high-rate charging/discharging is performed, the electrode active material of the entire electrode layer can be uniformly utilized, and excellent rate characteristics can be delivered.

The current collector-side surface of the electrode layer may be a region of the electrode layer, which occupies 30% in a thickness direction of the electrode layer from the current collector, and the opposite-side surface of the electrode layer may be a region of the electrode layer, which occupies 30% in a thickness direction of the electrode layer from the opposite surface of the electrode layer away from the current collector-side surface.

A concentration difference of the conductive material between at the opposite-side surface of the electrode layer and at the current collector-side surface of the electrode layer may be within a range of 0.1 wt % to 30 wt %.

Furthermore, the concentration difference of the conductive material between at the opposite-side surface of the electrode layer and at the current collector-side surface of the electrode layer may be within a range of 0.5 wt % to 5 wt %.

The concentration of the conductive material at the current collector-side surface may be within a range of 0.1 wt % to 30 wt %.

Furthermore, the concentration of the conductive material at the current collector-side surface may be within a range of 0.5 wt % to 5 wt %.

Besides, the concentration of the conductive material at the opposite-side surface may be within a range of 0.1 wt % to 30 wt %, or may also be within a range of 0.5 wt % to 5 wt %.

Besides, a content of the electrode active material is within a range of 60 wt % to 97 wt % relative to the electrode layer, or may also be within a range of 90 wt % to 97 wt % relative to the electrode layer.

The concentration of the conductive material in the electrode layer may be increased in a stepwise manner in the thickness direction of the electrode layer from the current collector.

The electrode layer may be formed by laminating a plurality of electrode layer-forming layers that differ in concentration of the conductive material with respect to one another.

Furthermore, the plurality of electrode layer-forming layers may be formed by coating a plurality of pastes, in sequence, that differ in the concentration of the conductive material over the current collector.

The concentration of the conductive material in the electrode layer may be increased in a continuous manner in the thickness direction from the current collector.

The electrode layer may be formed by utilizing a difference of specific gravity between the electrode active material and the conductive material.

Furthermore, the electrode layer may be formed by leaving at rest a paste that contains the electrode active material and the conductive material with a predetermined fluidity.

The thickness of the electrode layer may be within a range of 10 μm to 250 μm, or may also be within a range of 30 μm to 150 μm.

Besides, a lithium secondary battery according to a second aspect of the invention including i) a positive electrode body having a positive electrode current collector, and the positive electrode layer that is formed on the positive electrode current collector; ii) a negative electrode body having a negative electrode current collector, and a negative electrode layer that is formed on the negative electrode current collector; iii) a separator disposed between the positive electrode layer and the negative electrode layer; and iv) an organic electrolyte that conducts lithium ions between the positive electrode active material and the negative electrode active material. At least one of the positive electrode body and the negative electrode body is the electrode body described above.

According to the second aspect of the invention, since at least one of the positive electrode body and the negative electrode body employed is an electrode body described above, a lithium secondary battery that is excellent in the rate characteristics and the cycle characteristics can be provided.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view schematically showing an electrode body according to an embodiment of the invention;

FIG. 2 shows the concentration of a conductive material in the electrode body; and

FIG. 3 is a sectional view schematically showing a lithium secondary battery according to an embodiment of the invention.

### DETAILED DESCRIPTION OF EMBODIMENTS

Embodiments of the electrode body and the lithium secondary battery of the invention will be described in detail below.

Firstly, the electrode body of the invention will be described. The electrode body of the invention is an electrode body having a current collector, and an electrode layer that is formed on the current collector and that contains an electrode active material and a conductive material, and is characterized in that the concentration of the conductive material at a current collector-side surface of the electrode layer is lower than the concentration of the conductive material at an opposite-side surface that is opposite from the current collector-side surface.

According to the invention, since the concentration of the conductive material in the electrode layer is low at the current collector-side surface, and high at the opposite-side surface, it is possible to make the electro-conductivity uniform in the thickness direction of the electrode layer. Due to this construction, for example, even in the case where high-rate charging/discharging is performed, the electrode active material of the entire electrode layer can be uniformly utilized, and excellent rate characteristics can be delivered. Besides, since the degree of utilization of the electrode active material in the electrode layer is made uniform, the local degradation of the electrode active material can be prevented, and therefore the cycle characteristics can be improved. Likewise, since the degree of utilization of the electrode active material in the electrode layer is made uniform, the expansion/shrinkage of the electrode active material along with the charging/discharging can be mitigated in the electrode layer as a whole, so that the concentration of stress can be prevented and therefore the cycle characteristics can be improved.

The foregoing related-art electrode body is intended to minimize the amount of employed conductive material by making the concentration of the conductive material in the electrode layer high at the current collector-side surface and low at the opposite-side surface, and to heighten the energy density or the like by relatively increasing the amount of employed electrode active material. On the other hand, the electrode body of the invention, with attention focused on the non-uniformity of electro-conductivity in the thickness direction of the electrode layer, is intended to uniform the degree of utilization of the electrode active material and therefore improve the rate characteristics and the cycle characteristics by eliminating the non-uniformity of electro-conductivity by positively adding the conductive material at locations of large electronic resistance. That is, these two technologies are similar in terms of the gradient of concentration of the conductive material, but are entirely different in fundamental concept.

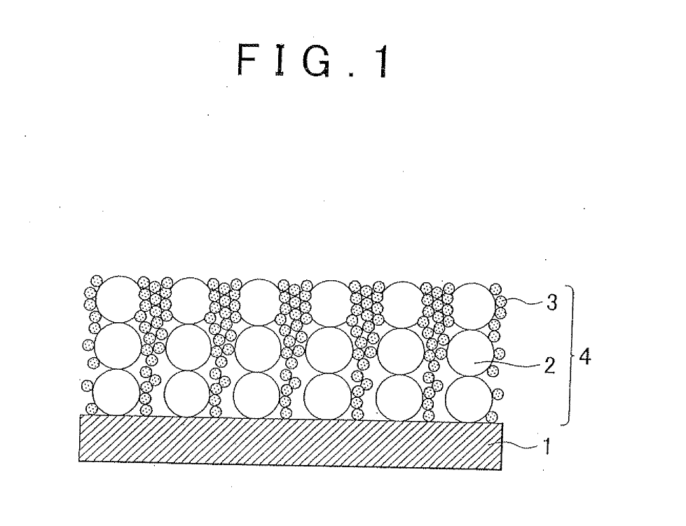

Next, the electrode body according to the embodiment of the invention will be described with reference to the drawings. FIG. 1 is a schematic sectional view showing an example of the electrode body of the invention. The electrode body shown in FIG. 1 has a current collector 1 (e.g., aluminum foil), and an electrode layer 4 that is formed on the current collector 1 and that contains an electrode active material 2 (e.g., LiCoO₂) and the conductive material 3 (e.g., carbon black). In this electrode body, the concentration of the conductive material 3 in the electrode layer 4 is increased in the thickness direction from the current collector 1.

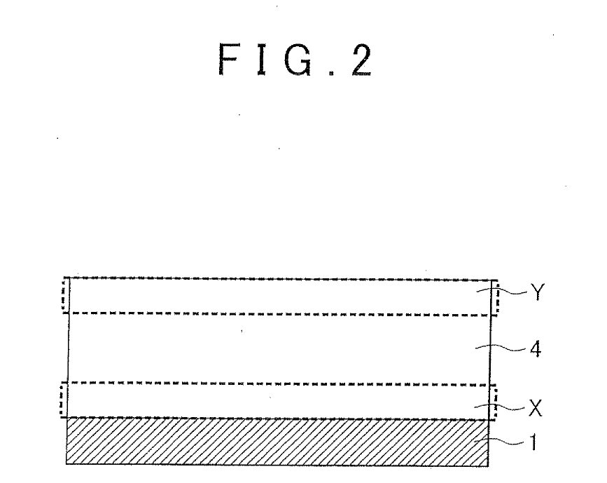

One of the features of the invention is that the concentration of the conductive material at the current collector-side surface of the electrode layer is lower than the concentration of the conductive material at the opposite-side surface that is opposite from the current collector-side surface. Hereinafter, the concentration of the conductive material in the electrode layer will be described with reference to FIG. 2. As shown in FIG. 2, the electrode layer 4 in the invention is formed on a surface of the current collector 1. Furthermore, the concentration of the conductive material at a surface of the electrode layer 4 that is on the current collector side (i.e., current collector-side surface X) is lower than the concentration of the conductive material at a surface of the electrode layer 4 that is opposite from the current collector-side surface X (i.e., opposite-side surface Y).

It is to be noted herein that the “current collector-side surface” in the invention refers to a region in the electrode layer that spreads at most from the interface between the electrode layer and the current collector to a location in the electrode layer that is located at 30% of the thickness of the electrode layer in the thickness direction of the electrode layer. On the other hand, the “opposite-side surface” refers to a region in the electrode layer that spreads at most from the surface opposite from the current collector-side surface to a location in the electrode layer that is located at 30% of the thickness of the electrode layer in the thickness direction of the electrode layer. The thickness of the electrode layer used in the invention varies depending on the use of the intended lithium secondary battery or the like. However, it is preferable that the thickness of the electrode layer be ordinarily within the range of 10 μm to 250 μm and, particularly, within the range of 20 μm to 200 μm and, more particularly, within the range of 30 μm to 150 μm.

In the invention, the concentration of the conductive materials at the current collector-side surface and the opposite-side surface can be measured by the following methods. For example, the measurement can be realized by a carbon sulfur analysis device, an ICP (i.e., optical emission spectrometry device), and an atomic absorption spectrometry device. In addition, concrete descriptions of, for example, the difference between the concentration of the conductive material at the current collector-side surface and the concentration of the conductive material at the opposite-side surface, will be given in detail below.

The electrode body of the invention may be a positive electrode body that has a positive electrode current collector and a positive electrode layer, or may also be a negative electrode body that has a negative electrode current collector and a negative electrode layer. Particularly, in the invention, it is preferable that the electrode body be a positive electrode body. This is because generally a material whose electro-conductivity is low is often used as a positive electrode active material. Hereinafter, the electrode body of the invention will be described separately for each of the constructions thereof.

Firstly, the electrode layer used in the invention will be described. The electrode layer used in the invention is formed on the current collector described below, and contains an electrode active material and a conductive material. Furthermore, in the electrode layer used in the invention, the concentration of the conductive material at the current collector-side surface of the electrode layer is lower than the concentration of the conductive material at the opposite-side surface opposite from the current collector-side surface. Hereinafter, the electrode layer used in the invention will be described separately for the material of the electrode layer, and the construction of the electrode layer.

The electrode layer used in the invention contains at least the electrode active material and the conductive material. Furthermore, the electrode layer may further contain a binder or the like, according to needs.

The electrode active material used in the invention is not particularly limited as long as the material is capable of storing and releasing lithium ions. Ordinarily, the electrode active material has electrical insulation characteristics. The electrode active material can be roughly divided between positive electrode active materials and negative electrode active materials in accordance with the application of the electrode body. Examples of the positive electrode active material include LiCoO₂, LiCoPO₄, LiMn₂O₄, LiNiO₂, LiFePO₄, LiCO_{1/3}Ni_{1/3}Mn_{1/3}O₂, LiMnPO₄ and LiNi_{0.5}Mn_{1.5}O₄. Particularly, LiCoO₂ is preferable. On the other hand, examples of the negative electrode active material include Li₄Ti₅O₁₂, LiTiO₂, SnO₂, SiO₂ and SiO. Particularly, Li₄Ti₅O₁₂ is preferable.

The content of the electrode active material relative to the electrode layer varies depending on the kind of the electrode active material. It is preferable that the content thereof be, for example, within the range of 60 wt % to 97 wt %, and particularly within the range of 75 wt % to 97 wt %, and more particularly within the range of 90 wt % to 97 wt %.

The conductive material used in the invention is not particularly limited as long as the material can improve the electro-conductivity of the electrode layer. Examples of the conductive material include carbon black, such as acetylene black, Ketjen black and other materials.

The electrode layer used in the invention may contain a binder according to needs. Examples of the binder include polyvinylidene fluoride (PVDF) and polytetrafluoroethylene (PTFE). Besides, it suffices that the content of the binder in the electrode layer be such an amount as to be able to fix the electrode active material and the like, and a less content thereof is more preferable. The content of the binder is ordinarily within the range of 1 wt % to 10 wt %.

Next, the construction of the electrode layer in the invention will be described. As described above with reference to FIG. 2, a feature of the invention is that the concentration of the conductive material at the current collector-side surface of the electrode layer is lower than the concentration of the conductive material at the opposite-side surface that is opposite from the current collector-side surface.

In the invention, it is preferable that the difference between the concentration of the conductive material at the current collector-side surface of the electrode layer and the concentration of the conductive material at the opposite-side surface of the electrode layer be, for example, within the range of 0.1 wt % to 30 wt %, and particularly within the range of 0.3 wt % to 10 wt %, and more particularly within the range of 0.5 wt % to 5 wt %. If the difference between the foregoing concentrations at the two surfaces is excessively small, there is possibility that the non-uniformity of electro-conductivity cannot be eliminated in the thickness direction of the electrode layer. On the other hand, if the difference therebetween is excessively large, the concentration of the conductive material at the opposite-side surface may become excessively high, for example, when the concentration of the conductive material at the current collector-side surface is heightened approximately to a level that allows the achievement of good electro-conductivity. In consequence, there is possibility of relative decrease of the concentration of the electrode active material contained at the opposite-side surface and therefore decline of the energy density of the electrode layer as a whole.

In the invention, the concentration of the conductive material at the current collector-side surface of the electrode layer is not particularly limited as long as the concentration allows good electro-conductivity to be secured. It is preferable that the concentration of the conductive material be, for example, within the range of 0.1 wt % to 30 wt %, and particularly within the range of 0.3 wt % to 10 wt %, and more particularly within the range of 0.5 wt % to 5 wt %. Within these ranges, good electro-conductivity can be obtained in the vicinity of the current collector.

In the invention, the concentration of the conductive material at the opposite-side surface of the electrode layer is not particularly limited as long as it is higher than the concentration of the conductive material at the current collector-side surface. It is preferable that the concentration of the conductive material at the opposite-side surface be, for example, within the range of 0.1 wt % to 30 wt %, and particularly within the range of 0.3 wt % to 10 wt %, and more particularly within the range of 0.5 wt % to 5 wt %. As long as the concentration of the conductive material at the opposite-side surface of the electrode layer is within the foregoing ranges, the degree of utilization of the electrode active material can be further uniformed in the thickness direction of the electrode layer.

In the invention, as long as the concentration of the conductive material at the opposite-side surface of the electrode layer is higher than the concentration of the conductive material at the current collector-side surface of the electrode layer, the concentration of the conductive material in an intermediate region therebetween in the electrode layer is not particularly limited. Particularly, in the invention, it is preferable that the concentration of the conductive material in the electrode layer is increased in a stepwise manner or in a continuous manner in the thickness direction from the current collector. This is because the degree of utilization of the electrode active material can be further uniformed.

The electrode layer in which the concentration of the conductive material is increased in a stepwise manner in the thickness direction from the current collector can be formed, for example, by coating a plurality of electrode layer-forming pastes that differ in the concentration of the conductive material over the current collector in sequence. Therefore, there is an advantage of easy manufacture. Assuming that the electrode layer is formed by laminating electrode layer-forming layers that differ in the concentration of the conductive material with respect to one another, it is preferable that the electrode layer be constructed of two to five electrode layer-forming layers, and it is particularly preferable that it be constructed of two or three electrode layer-forming layers. Besides, although the difference in the concentration of the conductive material between adjacent electrode layer-forming layers is not particularly limited, it is preferable that the difference be, for example, 1 wt % or higher, and particularly 2 wt % or higher. Furthermore, the content of the conductive material in each of the electrode layer-forming layers relative to the electrode layer 4 varies depending on the location of the electrode layer-forming layer. However, it is preferable that the content thereof be, for example, within the range of 0.1 wt % to 30 wt %, and particularly within the range of 0.3 wt % to 10 wt %.

The electrode layer in which the concentration of the conductive material is increased in a continuous manner in the thickness direction from the current collector has an advantage of it being possible to further uniform the degree of utilization of the electrode active material. The manufacture method for such an electrode layer will be described later.

Next, the current collector used in the invention will be described. The current collector used in the invention is not particularly limited as long as the current collector has a function of performing the collection of current with respect to the electrode layer. Besides, the current collector used in the invention is roughly divided into the positive electrode current collector and the negative electrode current collector according to the function of the electrode body.

Examples of the material of the positive electrode current collector include aluminum, SUS, nickel, iron and titanium. Particularly, aluminum and SUN are preferable. Besides, examples of the shape of the positive electrode current collector include a foil shape, a platy shape and a mesh shape. Particularly, the foil shape is preferable.

Examples of the material of the negative electrode current collector include copper, SUS and nickel. Particularly, copper is preferable. Besides, examples of the shape of the negative electrode current collector include a foil shape, a platy shape and a mesh shape. Particularly, the foil shape is preferable.

Next, a method for manufacturing the electrode body of the invention will be described. The method for manufacturing the electrode body of the invention is not particularly limited as long as the method is capable of providing the above-described electrode body.

For example, in the case where the electrode body of the invention has an electrode layer in which the concentration of the conductive material is increased in a stepwise manner in the thickness direction from the current collector, examples of the manufacture method for the electrode body include a method in which a plurality of electrode layer-forming pastes that each contain an electrode active material, a conductive material and a binder, and that differ in the concentration of the conductive material are prepared, and an operation of coating one of the pastes over the current collector and drying the paste is repeatedly performed, and finally the current collector with the dried pastes is pressed, and other methods.

Examples of the method for producing a plurality of electrode layer-forming pastes that differ in the concentration of the conductive material include a method in which equal amounts of an electrode active material are used in the individual electrode layer-forming pastes while the amount of the conductive material is varied from one paste to another. This method is able to uniform the electrode active material concentration in the electrode layer and therefore heighten the energy density. Another method to be cited is a method in which the amounts of the conductive material in the electrode layer-forming pastes are varied so that the total weights of the electrode active material and the conductive material in the electrode layer-forming pastes are the same. In this method, since the weights of the solutes contained in the electrode layer-forming pastes are the same, the density of the electrode layer can be made uniform, so that the cycle characteristics can be improved.

On the other hand, in the case where the electrode body of the invention has an electrode layer in which the concentration of the conductive material is increased in a continuous manner in the thickness direction from the current collector, examples of the manufacture method for the electrode body include a method in which the difference in specific gravity between the electrode active material and the conductive material is utilized, and other methods. Concretely, the specific gravity of LiCoO₂, used as an electrode active material, is about 5, and the specific gravity of carbon black, used as a conductive material, is about 2. Therefore, when an electrode layer-forming paste containing these materials and having a predetermined fluidity is prepared and applied on the current collector, and then when the electrode layer-forming paste with the fluidity of the electrode layer is left at rest, the electrode active material relatively tends to sink due to its great specific gravity, and the conductive material relatively tends to float due to its small specific gravity. This results in formation of an electrode layer in which the concentration of the conductive material is increased in a continuous manner in the thickness direction from the current collector. In addition, in the case where the specific gravity of the electrode active material is smaller than the specific gravity of the conductive material, a desired electrode layer can be obtained by inverting the electrode layer that has fluidity upside down when the electrode layer is left at rest. Besides, the obtained electrode layer may also be pressed to enhance the density of the electrode layer.

Next, the lithium secondary battery of the invention will be described. The lithium secondary battery of the invention is a lithium secondary battery having a positive electrode body that has a positive electrode current collector and a positive electrode layer formed on the positive electrode current collector, a negative electrode body that has a negative electrode current collector and a negative electrode layer formed on the negative electrode current collector, a separator disposed between the positive electrode layer and the negative electrode layer, and an organic electrolyte that conducts lithium ions between the positive electrode active material and the negative electrode active material, and at least one of the positive electrode body and the negative electrode body is one of the above-described electrode bodies.

According to the invention, since at least one of the positive electrode body and the negative electrode body is an above-described electrode body, a lithium secondary battery that is excellent in the rate characteristics and the cycle characteristics can be provided.

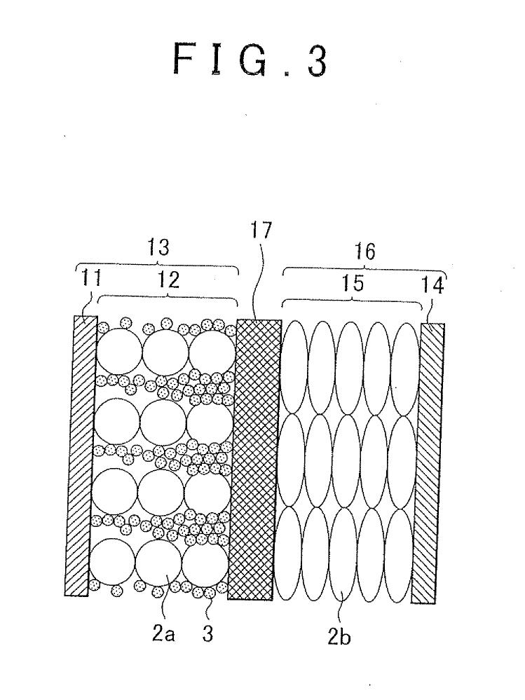

Next, the lithium secondary battery of the invention will be described with reference to the drawings. FIG. 3 is a schematic sectional view showing an example of the lithium secondary battery of the invention. The lithium secondary battery shown in FIG. 3 has a positive electrode body 13 that has a positive electrode current collector 11 and a positive electrode layer 12 formed on the positive electrode current collector 11, a negative electrode body 16 that has a negative electrode current collector 14 and a negative electrode layer 15 formed on the negative electrode current collector 14, a separator 17 disposed between the positive electrode layer 12 and the negative electrode layer 15, and an organic electrolyte (not shown) that conducts lithium ions between a positive electrode active material 2a and a negative electrode active material 2b. Furthermore, in the positive electrode body 13 of the lithium secondary battery, the concentration of a conductive material 3 in the positive electrode layer 12 is increased from the positive electrode current collector 11 toward the separator 17. Hereinafter, the construction of the lithium secondary battery of the invention will be described in detail.

Firstly, the positive electrode body and the negative electrode body used in the invention will be described. The positive electrode body used in the invention has a positive electrode current collector, and a positive electrode layer formed on the positive electrode current collector. The negative electrode body used in the invention has a negative electrode current collector, and a negative electrode layer formed on the negative electrode current collector.

In the invention, ordinarily, an electrode body as described above is used as at least one of the positive electrode body and the negative electrode body. Particularly, in the invention, it is preferable that the above-described electrode body be used at least as the positive electrode body. This is because generally a material whose electro-conductivity is low is often used as a positive electrode active material. Besides, in the invention, the above-described electrode body may be used as each of the positive electrode body and the negative electrode body.

In the invention, in the case where the above-described electrode body is used only as the negative electrode body, the positive electrode body used may be a common positive electrode body. The positive electrode active material, the positive electrode current collector, the conductive material and the binder, which are used to form the electrode body, are the same as described above in conjunction with the electrode body, and the descriptions thereof are omitted herein.

In the invention, in the case where the above-described electrode body is used only as the positive electrode body, the negative electrode body used may be a common negative electrode body. The negative electrode active material used is not particularly limited as long as the material is capable of storing and releasing lithium ions. Examples of the negative electrode active material include metallic lithium, lithium alloys, metal oxides, metal sulfides, metal nitrides, carbon-based materials such as graphite and the like, and other materials. Besides, the negative electrode active material may be in a powder form, or may also be a thin-film form. Besides, the negative electrode current collector, the conductive material and the binder, which are used to form the electrode body, are the same as described above in conjunction with the electrode body, and descriptions thereof are omitted herein.

The organic electrolyte used in the invention has a function of conducting lithium ions between the positive electrode active material and the negative electrode active material. Concretely, examples of the organic electrolyte include an organic electrolyte solution, a polymer electrolyte and a gel electrolyte.

The organic electrolyte solution used is ordinarily a non-aqueous electrolyte solution that contains a lithium salt and a non-aqueous solvent. The lithium salt is not particularly limited as long as it is a lithium salt that is used in a common lithium secondary battery. Examples of the lithium salt include LiPF₆, LiBF₄, LiN(CF₃SO₂)₂, LiCF₃SO₃, LiC₄F₉SO₃, LiC(CF₃SO₂)₃ and LiClO₄. The non-aqueous solvent is not particularly limited as long as it is capable of dissolving the lithium salt. Examples of the non-aqueous solvent include propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolan, nitromethane, N,N-dimethyl formamide, dimethyl sulfoxide, sulfolan and γ-butyrolactone. As for these non-aqueous solvents, only one species of these non-aqueous solvents may be used, or a mixture of two or more species thereof may also be used. Besides, the non-aqueous electrolyte solution used herein may be an ambient temperature molten salt.

The polymer electrolyte contains a lithium salt and a polymer. The lithium salt used may be the same as the lithium salt used in the foregoing organic electrolyte solution. The polymer is not particularly limited as long as the polymer forms a complex together with a lithium salt. Examples of the polymer include polyethylene oxide, and the like.

The gel electrolyte contains a lithium salt, a polymer, and a non-aqueous solvent. The lithium salt and the non-aqueous solvent used may be the same as the lithium salt and the non-aqueous solvent used in the foregoing organic electrolyte solution. Besides, the polymer is not particularly limited as long as the polymer is able to gelate. Examples of the polymer include polyethylene oxide, polypropylene oxide, polyacrylonitrile, polyvinylidene fluoride (PVDF), polyurethane, polyacrylate and cellulose.

The lithium secondary battery in the invention ordinarily has a separator that is disposed between the positive electrode layer and the negative electrode layer. The separator is not particularly limited as long as it has a function of retaining the organic electrolyte. Examples of the separator include porous membranes of polyethylene, polypropylene, or non-woven fabrics such as a resin non-woven fabric or a glass fiber non-woven fabric.

Besides, the shape of the battery case used in the invention is not particularly limited as long as the battery case is capable of housing the foregoing positive electrode body, the foregoing negative electrode body, the foregoing separator, and the foregoing organic electrolyte. Concretely, examples of the shape of the battery case include a cylindrical shape, a square shape, a coin shape, and a laminated shape. Besides, the lithium secondary battery in the invention has an electrode that is constructed of the positive electrode layer, the separator, and the negative electrode layer. The shape of the electrode is not particularly limited. Concretely, examples of the shape of the electrode include a flat plate type, and a rolled type. Besides, the manufacture method of the lithium secondary battery of the invention is the same as a common manufacture method for a lithium secondary battery, and description thereof is omitted herein.

The invention is not limited to the foreign embodiments. The foregoing embodiments are merely illustrative, and the technical scope of the invention encompasses any construction and the like that has substantially the same construction and has the same or similar operation and effects as the technical ideas described in the appended claims.

Hereinafter, the invention will be further concretely described below with reference to Examples. 90 g of lithium cobaltate (LiCoO₂) as a positive electrode active material and 5 g of carbon black as an conductive material were added into 125 mL of n-methylpyrrolidone solution as a solvent with 5 g of polyvinylidene fluoride (PVDF) as a binder having been dissolved therein. The mixture was kneaded until it was homogeneously mixed. Thus, a positive electrode layer-forming paste α was obtained. Next, a positive electrode layer-forming paste β was obtained in substantially the same manner as described above, except that the 87 g of lithium cobaltate and 8 g of carbon black were used. Next, a positive electrode layer-forming paste γ was obtained in substantially the same manner as described above, except that the 85 g of lithium cobaltate and 10 g of carbon black were used.

After that, the positive electrode layer-forming paste a was applied to one side of a 15-μm-thick Al current collector to the amount per unit area of 2 mg/cm², and was dried. Subsequently, the positive electrode layer-forming paste β was applied in the same manner to the amount per unit area of 2 mg/cm², and was dried. Subsequently, the positive electrode layer-forming paste γ was applied in the same manner to the amount per unit area of 2 mg/cm², and was dried. Using these pastes, an electrode in which the amount of the conductive material used increased in three steps in the thickness direction from the positive electrode current collector side. Next, this electrode was pressed to obtain a thickness of 40 μm and a density of 2.5 g/cm³. Finally, this electrode was cut so that a cut positive electrode of φ16 mm in diameter was obtained.

92.5 g of graphite powder as a negative electrode active material was added into 125 mL of the solvent n-methylpyrrolidone solution with 7.5 g of polyvinylidene fluoride (PVDF) having been dissolved as a binder. The mixture was kneaded until it was homogeneously mixed. Thus, a negative electrode layer-forming paste was produced. This negative electrode layer-forming paste was applied to one side of a 15-μm-thick Cu current collector to the amount per unit area of 4 mg/cm², and was dried, whereby an electrode was obtained. This electrode was pressed to obtain a thickness of 20 μm and a density of 1.2 g/cm³. Finally, this negative pole electrode body was cut so that a negative electrode of φ19 mm in diameter was obtained.

Using the positive electrode and the negative electrode obtained as described above, CR2032-type coin cells were produced. Incidentally, the separator used was a PP-made separator, and the electrolyte solution used was a solution obtained by dissolving lithium hexafluorophosphate (LiPF₆) as a supporting electrolyte to the concentration of 1 mol/L in a mixture obtained by mixing EC (ethylene carbonate) and DMC (dimethyl carbonate) at a ratio of 3:7 by volume.

As a first comparative example, a coil cell was obtained in substantially the same manner as the foregoing example, except that the positive electrode was produced by coating only the positive electrode layer-forming paste β over the positive electrode current collector to the amount per unit area of 6 mg/cm².

As a second comparative example, a coil cell was obtained in substantially the same manner as the foregoing example, except that the positive electrode is formed by coating the positive electrode layer-forming paste γ, the positive electrode layer-forming paste β and the positive electrode layer-forming paste α in sequence.

Using the coin cells obtained in the foregoing example and the first and second comparative examples, evaluation of the rate characteristics and the cycle characteristics was performed. The measurement method was as follows.

For the evaluation of the rate characteristics at 25° C., the following operations (a) to (f) were performed: (a) the conditioning at 3.0 to 4.1 V, (b) the CCCV charging at 1 C up to an upper limit of 4.1 V for 2.5 hours, (c) the CC discharging at an electric current value of C/3 down to a lower limit of 3.0 V, (d) the CCCV charging at 1 C up to an upper limit of 4.1 V for 2.5 hours, (e) the CC discharging at an electric current value of 1 C down to a lower limit of 3.0 V, and (f) the process of (b) to (e) of the CCCV charging and the CC discharging was repeatedly performed. The CC discharge current was changed in the sequence of 3 C, 5 C, 10 C, 20 C and 40 C. After that, the discharge capacity at the 40 C discharge, and the discharge capacity at the C/3 discharge were calculated. Results are shown in Table 1.

For the evaluation of the cycle characteristics, the following operations (a) to (f) were performed, and subsequently in the operation (g), 500-cycle charge/discharge was performed at 2 C and 3.0 to 4.1 V (performed at 60° C.), After that, a discharge capacity maintenance rate was calculated from the first-cycle discharge capacity and the 500th-cycle discharge capacity. Results are shown in Table 1.

TABLE 1

| | | | 40 C. | Dis- |
|---|---|---|---|---|
| | | Concentration of | discharge | charge |
| | | the conductive | capacity | capacity |
| | Conduc- | maintenance | C/3 | mainte- |
| | tive | (from current | discharge | nance |
| | material | collector side) | capacity | rate (%) |
| Example 1 | Carbon | 5 wt % (1st layer) | 70 | 85 |
| | Black | 8 wt % (2nd layer) | | |
| | | 10 wt % (3rd layer) | | |
| Comparative | Carbon | 8 wt % | 60 | 75 |
| Example 1 | Black | | | |
| Comparative | Carbon | 10 wt % (1st layer) | 65 | 70 |
| Example 2 | Black | 8 wt % (2nd layer) | | |
| | | 5 wt % (3rd layer) | | |

As shown in Table 1, it was confirmed that the coil cell of the example was better in the rate characteristics and the cycle characteristics than the coin cells of the first comparative example and the second comparative example.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the claimed invention.

1. A electrode body comprising:
a current collector, and
an electrode layer that is formed on the current collector and that contains an electrode active material and a conductive material,
wherein the concentration of the conductive material at a current collector-side surface of the electrode layer is lower than the concentration of the conductive material at an opposite-side surface that is opposite from the current collector-side surface.

2. The electrode body according to claim 1, wherein:
the current collector-side surface of the electrode layer is a region of the electrode layer, which occupies 30% in a thickness direction of the electrode layer from the current collector; and
the opposite-side surface of the electrode layer is a region of the electrode layer, which occupies 30% in a thickness direction of the electrode layer from the opposite-side surface of the electrode layer away from the current collector-side surface.

3. The electrode body according to claim 1, wherein a concentration difference of the conductive material between at the opposite-side surface of the electrode layer and at the current collector-side surface of the electrode layer is within a range of 0.1 wt % to 30 wt %.

4. The electrode body according to claim 3, wherein the concentration difference of the conductive material between at the opposite-side surface of the electrode layer and at the current collector-side surface of the electrode layer is within a range of 0.5 wt % to 5 wt %.

5. The electrode body according to claim 1, wherein a concentration of the conductive material at the current collector-side surface is within a range of 0.1 wt % to 30 wt %.

6. The electrode body according to claim 5, wherein the concentration of the conductive material at the current collector-side surface is within a range of 0.5 wt % to 5 wt %.

7. The electrode body according to claim 1, wherein a concentration of the conductive material at the opposite-side surface is within a range of 0.1 wt % to 30 wt %.

8. The electrode body according to claim 7, wherein the concentration of the conductive material at the opposite-side surface is within a range of 0.5 wt % to 5 wt %.

9. The electrode body according to claim 1, wherein a content of the electrode active material is within a range of 60 wt % to 97 wt % relative to the electrode layer.

10. The electrode body according to claim 9, wherein the content of the electrode active material is within a range of 90 wt % to 97 wt % relative to the electrode layer.

11. The electrode body according to claim 1, wherein the concentration of the conductive material in the electrode layer is increased in a stepwise manner from the current collector in the thickness direction of the electrode layer.

12. The electrode body according to claim 11, wherein the electrode layer is formed by laminating a plurality of electrode layer-forming layers that differ in concentration of the conductive material with respect to one another.

13. The electrode body according to claim 12, wherein the plurality of electrode layer-forming layers are formed by coating a plurality of pastes that differ in the concentration of the conductive material over the current collector in sequence.

14. The electrode body according to claim 1, wherein the concentration of the conductive material in the electrode layer is increased in a continuous manner from the current collector in the thickness direction.

15. The electrode body according to claim 14, wherein the electrode layer is formed by utilizing a difference of specific gravity between the electrode active material and the conductive material.

16. The electrode body according to claim 15, wherein the electrode layer is formed by leaving at rest a paste that contains the electrode active material and the conductive material with a predetermined fluidity.

17. The electrode body according to claim 1, wherein the thickness of the electrode layer is within a range of 10 μm to 250 μm.

18. The electrode body according to claim 17, wherein the thickness of the electrode layer is within a range of 30 μm to 150 μm.

19. A lithium secondary battery comprising:
a positive electrode body having a positive electrode current collector, and a positive electrode layer that is formed on the positive electrode current collector;
a negative electrode body having a negative electrode current collector, and a negative electrode layer that is formed on the negative electrode current collector;
a separator disposed between the positive electrode layer and the negative electrode layer; and
an organic electrolyte that conducts lithium ions between a positive electrode active material and a negative electrode active material,
wherein at least one of the positive electrode body and the negative electrode body is the electrode body according to claim 1.
